(19) United States
(12) Patent Application Publication
(10) Pub. No.: US 2014/0022646 A1
(43) Pub. Date: Jan. 23, 2014

(54) Adapter Sleeve For Observation Telescope

(71) Applicant: Swarovski-Optik KG., Absam (AT)

(72) Inventor: Patrick Kurz, Zirl (AT)

(21) Appl. No.: 13/913,781

(22) Filed: Jun. 10, 2013

(30) Foreign Application Priority Data
Jun. 11, 2012 (AT) A 668/2012

(51) Int. Cl. G02B 7/00; G02B 25/00

(52) U.S. Cl. CPC G02B 7/003; G02B 25/001
USPC 359/643

(57) ABSTRACT

The invention relates to an adapter sleeve for fastening an accessory, such as a fixture for an optical recording or measuring device, to an eyepiece portion of an observation telescope. The adapter sleeve has a basic body that centers the adapter sleeve on the eyepiece portion, an attachment portion that fastens the accessory to the adapter sleeve, and a fixing device that locks the adapter sleeve at the eyepiece portion. Likewise, the present invention relates to different fixtures for attaching an optical recording or measuring device to the eyepiece portion of an observation telescope. This provides both an adapter sleeve and a fixture that meets increased positioning accuracy requirements, while being adjustable to fit the needs of different observation telescopes and optical recording or measuring devices.

The invention relates to an adapter sleeve for an observation telescope according to the preamble of claim 1, an attachment adapter according to the preamble of claim 17, an adapter system according to the preamble of claim 18 and an eyepiece arrangement according to the preamble of claim 19.

Observation telescopes are frequently not only used for direct observation, but often, the image created is recorded and processed by a further optical recording or measuring device attached to the eyepiece of an observation telescope. During nature observations, for example, in addition to the direct observation frequently also images of the observed scenes are recorded and this may require a camera to be attached to and detached from the observation telescope several times. In order to ease this, particular fixtures have been developed, which may be used to attach or detach a camera to and from the observation camera quickly and without tools, and a high position accuracy has to be achieved at the same time, in order to avoid aberrations caused by lacking alignment of optical axes.

Corresponding fixtures must ensure a perfect fitting at both the observation telescope and at the recording device or the measuring device and such fixtures are to be suitable for the respectively used types. In order to avoid the need for an absolutely individual fixture for each of the combinations of observation telescopes and recording devices, it has been known to attach fixtures, which are suitable for a particular recording device, not directly to an eyepiece, but by means of an adapter attached to the eyepiece. Such a fixture corresponds for example to the digital camera adapter TYPE DCA of the applicant. The adapter sleeve to be attached to the eyepiece, in which adapter sleeve a radially acting clamping screw is disposed, has in this case a considerably larger diameter than the eyepiece itself and may impair the handiness of the observation telescope.

In the course of the further development of the optical quality of the image for both observation telescopes and recording or measuring devices, also the requirements for such fixtures in terms of accuracy during positioning while mounting recording or measuring devices, or accessories in general are increasing. It is at the same time required for such fixtures to be adaptable to different devices to be attached with the aid of appropriate adapters. The disadvantage is in this case furthermore that eyepiece portions are, due to their shape or mechanical strength, frequently not configured for the later attachment of accessories or adapter sleeves, in particular if it is tried to attach an unsuitable or inappropriate fixture.

The objective of the invention is to propose an adapter sleeve or eyepiece arrangement having an adapter sleeve which meets the increased requirements in terms of positioning accuracy and which may be produced cost-efficiently at the same time. The adapter sleeve is furthermore supposed to offer an improvement in the event that the model of observation telescope or of optical recording or measuring device is changed.

The objective of the invention is achieved by an adapter sleeve of the generic kind having the characterizing features of claim 1 or an attachment adapter provided therewith having the features of claim 17.

Due to the fact that the external centering surface comprises at least two external centering sections having a constant external diameter each, with the external diameter of the external centering sections increasing in observation direction, it is possible to achieve advantageous effects. The following embodiments refer to the used terms accessory and fixture equivalently.

When they are combined with an appropriately embodied fixture, the several external centering sections with different external diameters result in a higher positioning accuracy, because radial clearance fits result at the individual step, and the largest present clearance fit is reduced by a slighter clearance fit of further steps, which is not the case for an exterior circumferential surface having one single constant external diameter, but in this case, the one and only and, at the same time, largest radial clearance fit is effective. Assuming that it is possible for the adapter sleeve according to the invention to achieve identical manufacturing tolerances as for known embodiments, it is possible that this measure increases the positioning accuracy of a fixture with little effort.

This to some extent leveled shape of the external surface furthermore allows that an adapter sleeve adapted to this shape is axially slid on more easily, as the external diameter of the observer-side first external centering section is smaller than the external centering section(s) following in observation direction.

In addition, that kind of design of the external surface motivates a corresponding design of the fixture, in order to allow an optimum centering at the thereby formed interface across a length as long as possible. It is thus possible to avoid the usage of unsuitable designs of fixtures that would for example mechanically overload the adapter sleeve or also the eyepiece portion surrounded by the adapter sleeve, e.g. by unsuitable fastening means being used. Hence the particular shape of the adapter sleeve makes attaching unsuitable fixtures more difficult.

Due to the fact that each of the external centering sections has as constant external diameter, it is possible to align the accessory in axial direction and to fasten it in different positions by using a suitable design of fastening means at the fixture.

An advantageous embodiment of the adapter sleeve is that the external diameter from one of the external centering section to the subsequent external centering section increases by a value between 1% and 10%. With an advantageous embodiment, the diameter of the first external centering section is for example 62 mm and the diameter of the second external centering section is 63 mm. Even such a slight gradation may cause the previously described advantageous effects and it is at the same time possible to work with low material thicknesses, with the result that the handiness of the observation telescope is hardly changed by the adapter sleeve.

In another advantageous embodiment, the attachment portion may be disposed between external centering sections spaced apart from each other in observation direction. It is thus allowed for the fixture to rest against external centering sections on both sides of the attachment portions, with the result that possible oblique positions of the fixture are reduced due to the present clearance fit and the working clamping forces exercised by the fastening means.

This being the case, the attachment portion may have an external diameter reduced with respect to the external centering sections and be formed as a recess, flute or groove extending across the entire external circumference of the adapter sleeve. Such an attachment portion may also be referred to as intermediate section and a fastening element of the accessory may engage therein and thus, a positively locking axial position locking of the accessory may be provided. It is furthermore thereby possible to be able to pivot the accessory around the optical axis, when the fastening element is slightly loosened without the axial position being changed.

As it is related to production not always easy to achieve a resting of the adapter sleeve at the eyepiece portion over the entire area with minimal tolerances, it is possible for the centering function to be reduced to smaller part sections, for which it is easier to meet a high production accuracy. For this purpose, the external centering surface may comprise at least two external centering sections spaced apart from each other by an intermediate section having a reduced diameter. At identical total tolerances, the spacing causes a smaller possible tilting angle of the adapter sleeve due to the larger base.

In order to allow the usage of flat fastening means without considerable enlarging the total construction length of the adapter sleeve, it is advantageous if the recess in observation direction has a dimension of 5 mm and 12 mm.

If the external centering surface and/or the attachment portion of the external surface viewed in observation direction is at least partly arranged behind the fixing device, the effects of a clearance fit existing at the centering surfaces between eyepiece portion and the adapter sleeve as well as between the adapter sleeve and an accessory are reduced and the positioning accuracy is thereby increased. For this reason, it is also for fixing devices that are simple in terms of construction possible to be used, which also results in a greatest possible flexibility for the design of the accessories to be attached to the adapter sleeve. Due to the spatial separation of the functions fixing the adapter sleeve and fastening or centering the accessory, it is furthermore possible to keep the total diameter of the adapter sleeve and its external dimensions small altogether. This being the case, the fixing device may exert fastening forces onto the eyepiece portion in radial and/or axial direction, which forces may furthermore be increased by the fastening forces of the accessory.

The compensation of possible minimal oblique positions of the adapter sleeve and the accessory is continued to be increased if the external centering surface and/or the attachment portion of the external surface is in observation direction completely arranged in accordance with the fixing device. Viewed across the length of the adapter sleeve, a functional structuring into fixing the adapter sleeve and fastening the accessory is thus achieved, with the result that the respective sections may be adjusted to the functions to be met optimally accordingly.

The above-mentioned advantages may be achieved despite a short total length of the adapter sleeve, if the fixing device is arranged in the end section of the adapter sleeve on the observer's side, in particular in the outermost third on the observer's side.

A high level of repeat accuracy for the axial positioning of an accessory at the eyepiece portion may be achieved when the external surface of the adapter sleeve has a stop element for the accessory which stop element radially protrudes outwardly, in particular having the form of an external collar at the objective side end section of the adapter sleeve. By means of this, it is furthermore possible to avoid collisions between the eyepiece portion and the optical accessory device, since the path of the accessory is limited by the stop element.

It can furthermore be of advantage if one of the external centering sections has a transition section having conically increasing external diameter arranged in advanced, with the result that no sharp step is present ahead of this external centering section and it is thus easier to slide on the fixture.

If the attachment portion at the external surface coincides with an inner centering surface at the inner surface, the adapter sleeve is in this region supported by the eyepiece portion from the interior and it is possible for the attachment portion to absorb high fastening forces despite thin wall thickness, as the latter are also transferred into the eyepiece portion.

A transfer of the fastening forces exercised by the accessory to the adapter sleeve into the eyepiece portion engaged by the adapter sleeve is made easier if the basic body in the attachment portion has a locally thinner wall thickness than in the adjacent sections and may thus locally yield or deflect slightly and be made to rest against the eyepiece portion. This being the case, a saving in material of the adapter sleeve may be achieved without losses in terms of positioning accuracy.

The adapter sleeve may also have a stop element radially protruding inwardly at the basic body, which stop element forms a stop surface for axial resting the adapter sleeve at an end face of the eyepiece portion, with the result that a certain and each time identical position of the adapter sleeve may be achieved in the direction of the optical axis. Additionally, this stop element may be used for fixing the adapter sleeve in axial direction, used in addition or as an alternative to a fixing by radial fastening forces.

An advantageous embodiment of a fixing device is a clamping device having resilient and circumferentially distributed clamping elements at the basic body, in particular in the form of a collet, and having a clamping body, particularly in the form of a cap nut, radially displacing the clamping elements. Compared to a fastening by means of one or several radially arranged clamping screws, it is possible to achieve fixing forces that are more evenly distributed on the eyepiece portion.

The fixing device can alternatively comprise a stop element radially protruding inwardly having a stop surface for axial resting the basic body on the eyepiece portion and an axial tensioning element that may be attached to the latter, with the result that radial forces onto an eyepiece housing and therefrom resulting deformations can be reduced.

This being the case, it is advantageously possible for the axial tensioning element to be formed from an eye cup arrangement that may be screwed into the eyepiece portion and thereby, an anyway existing component part of the eyepiece arrangement may be used for an additional function.

It is in particular possible for the above-mentioned advantageous effects to be used with an attachment adapter according to claim 16.

The objective of the invention is achieved by an adapter system having the features described in claim 18. By combining adapter sleeves having variable interior design and fixtures having variable exterior embodiments, the usage or the exchange of the adapter sleeve offers a cost-efficient solution for using an existing fixture for an optical accessory device on different observation telescopes, even if the eyepiece portions of the latter have different dimensions.

The objective of the invention is furthermore achieved by an eyepiece arrangement having the features described in claim 19. By fixing the adapter sleeve in axial direction with the eye cup arrangement, it is possible for radial forces to be reduced to the eyepiece portion and a cost-efficient embodiment of a fixing device for an adapter sleeve which is simple in terms of construction is present.

If in this case, the external diameter of the axial pressing face of the eye cup arrangement approximately corresponds to the external diameter of the eyepiece housing, it is possible for the axial fastening forces to be distributed optimally, without constraining the axial attachment of an accessory.

To provide a clearer understanding, the invention will be described in more detail below with reference to the appended drawings.

The simplified, schematic drawings illustrate the following:

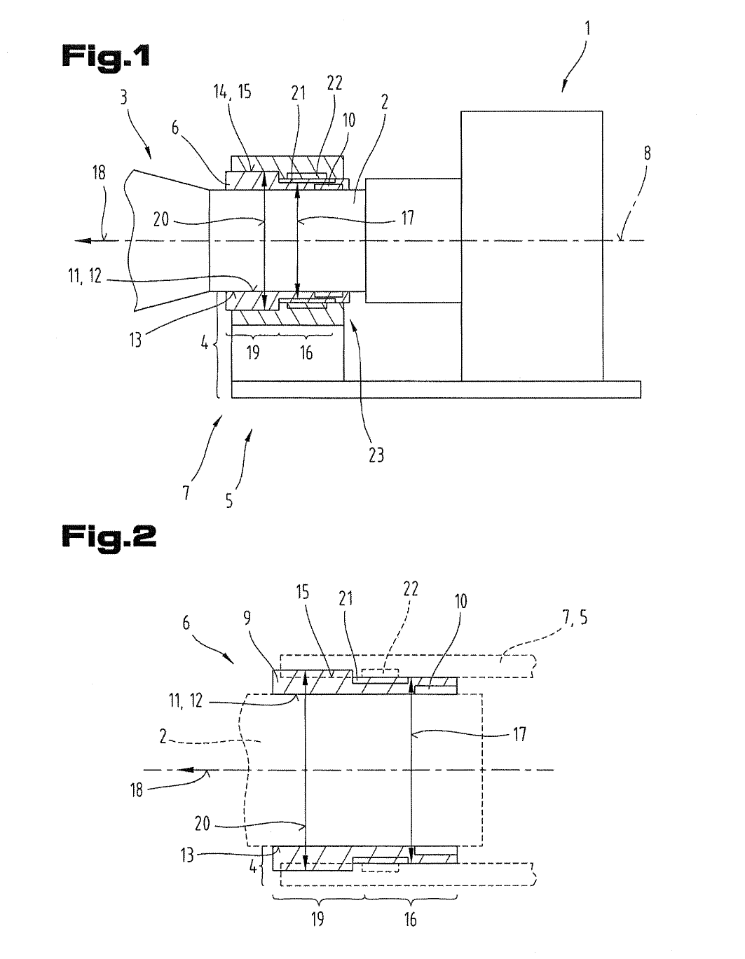

FIG. 1 an eyepiece portion with adapter sleeve and thereto attached accessory;

FIG. 2 a longitudinal section through a further embodiment of an adapter sleeve;

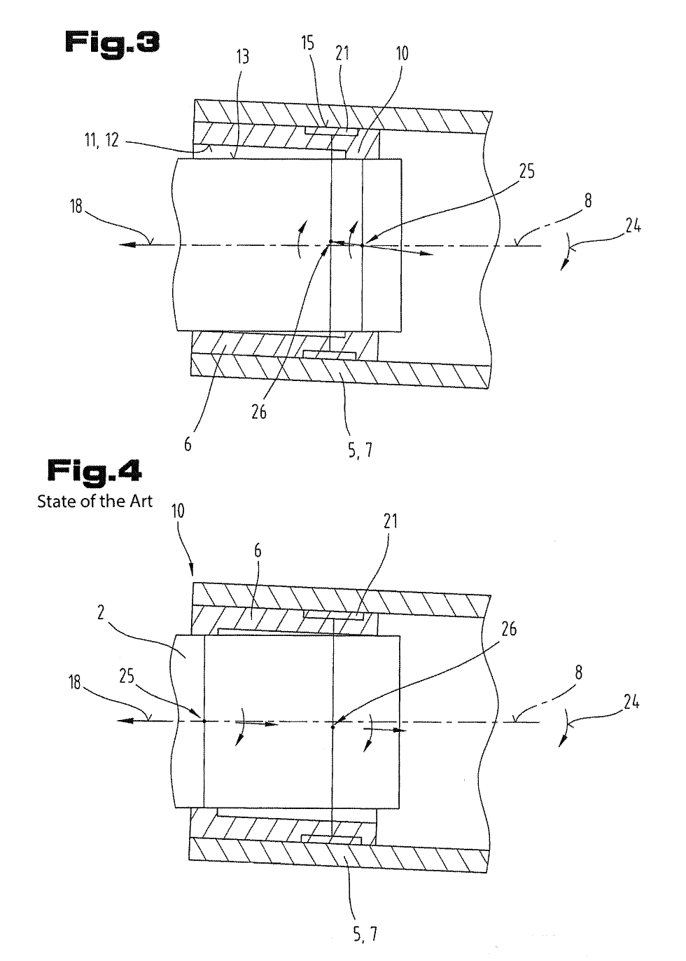

FIG. 3 a longitudinal section through an adapter sleeve illustrating positioning tolerances;

FIG. 4 a longitudinal section through an adapter sleeve according to prior art illustrating positioning tolerances;

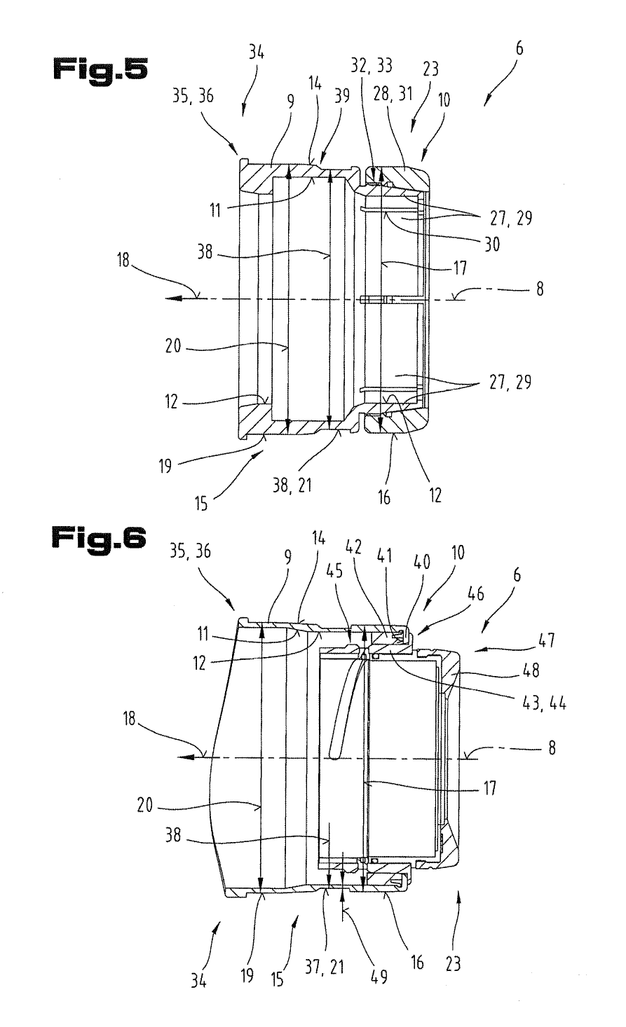

FIG. 5 a longitudinal section through a further embodiment of an adapter sleeve;

FIG. 6 a longitudinal section through a further embodiment of an adapter sleeve;

FIG. 7 a longitudinal section through a eyepiece arrangement according to the invention;

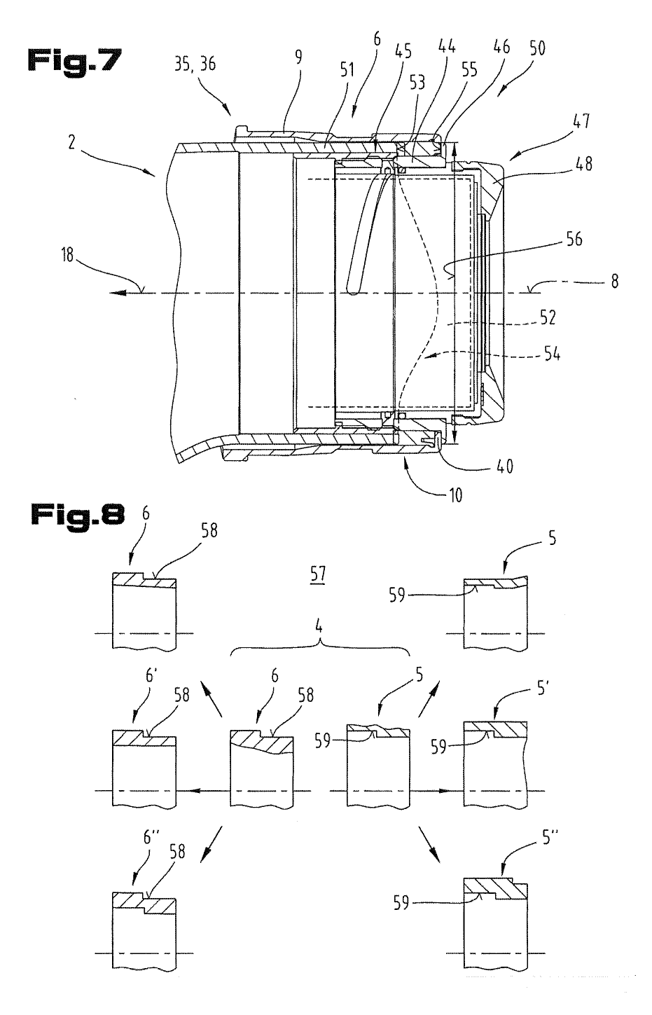

FIG. 8 an adapter system made of different adapter sleeves and fixtures.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All of the details relating to value ranges in the present description are defined such that the latter include any and all part ranges, e.g. a range of 1 to 10 means that all part ranges, starting from the lower limit of 1 to the upper limit 10 are included, i.e. the whole part range beginning with a lower limit of 1 or above and ending at an upper limit of 10 or less, e.g. 1 to 1.7, or 3.2 to 8.1 or 5.5 to 10.

In schematic side view, FIG. 1 shows the attachment of an optical recording or measuring device 1 at an eyepiece portion 2 of an observation telescope 3 by means of an attachment adapter 4. The attachment adapter 4 comprises a fixture 5 and provides for the recording or measuring device 1 to be positioned firmly with respect to the observation telescope 3. The fixture 5 is at the same time to be detachable from the eyepiece portion 2 with only a few hand moves and to be attachable to the latter in the same easy way, in order to enable the user to quickly and simply switch between observing an object through the observation telescope 3 and using the recording or measuring device 1.

As shown by FIG. 1, the fixture 5 is not directly fastened to the eyepiece portion 2, but the attachment adapter 4 also comprises an adapter sleeve 6 attached to the eyepiece portion 2 and the fixture 5 is fastened to the adapter sleeve 6, which may stay at the eyepiece portion 2 permanently and allows not only normal observing through the observation telescope 3 but also a simple attaching and detaching of the fixture 5 to and from the recording or measuring device 1.

The eyepiece portion 2 has an essentially cylindrical shape may thereby correspond to the actual eyepiece of the observation telescope 3 or to a cylindrical housing part on the observer's side of the observation telescope 3.

It is not only possible for the adapter sleeve 6 to be used for fastening a fixture 5, but also generally, for fastening any part of accessory 5 to the eyepiece portion 2.

The purpose of the adapter sleeve 6 is to bring an accessory 7 into a position defined with respect to the optical axis 8 of the observation telescope 3 and this positioning may also always be effected with the required positioning accuracy for several attaching processes or detaching processes. In order to achieve this, it is required that the adapter sleeve 6 may be fixed to the eyepiece portion 2 as well as the accessory 7 may be fixed to the adapter sleeve 6 in a defined position each. Apart from the axial positioning, this in particular applies to measures for centering the adapter sleeve 6 at the eyepiece portion 2 and an accessory 7 at the adapter sleeve 6, with the result that it is for example for an optical axis of a recording or measuring device 1 to be positioned exactly in the optical axis 8 of the observation telescope 3.

The adapter sleeve 6 is essentially made of a basic body 9 similar to a hollow-cylinder and comprises the eyepiece portion 2 at an external circumference. For a form- and/or force-locked position locking of the adapter sleeve 6 at the eyepiece portion 2, the latter further comprises a fixing device 10, by means of which the required fastening forces between the adapter sleeve 6 and the eyepiece portion 2 may be transferred.

The centering of the adapter sleeve at the eyepiece portion 2 is effected at its inner surface 11, having at least one inner centering surface 12 contacting the eyepiece portion 2. Preferably, the inner centering surface 12 cooperates with an external circumference 13 of the eyepiece portion 2, it is nevertheless possible that the centering takes place at an end face but even also at an interior face of the eyepiece portion 2.

The attachment of an accessory 7 to the adapter sleeve 6 is effected at an external surface 14 of the adapter sleeve 6, with the latter having an external centering surface 15 for reasons of centering the accessory 7, which external centering surface 15 is provided for bringing the accessory 7 into a position defined with respect to the adapter sleeve 6 and thus also with respect to the observation telescope 3.

The external centering surface 15 comprises a first external centering section 16 on the observer's side having a constantly smaller external diameter 17 and subsequently, in observation direction 18, a second external centering section 19 having a constantly greater diameter 20. Thereby, the accessory 7 is not only centered at one cylindrical section, but at least at two different cylindrical sections, with the result that an exact positioning may be effected. This being the case, the inner surface of the accessory 7, e.g. the fixture 5 has preferably also two sections having different diameters.

The external surface 14 has furthermore an attachment portion 21, where fastening forces between the accessory 7 and the adapter sleeve 6 are transferred. For this purpose, fastening means 22 are provided in the accessory 7, with the result that it is possible for the accessory 7 to be detachably connected to the adapter sleeve 6. The fastening means 22 may e.g. be formed by clamping screws, clamping elements, clamping rings, clamping sleeves, etc.

As shown in FIG. 1, the external centering sections 16, 19 and the attachment portion 21 are disposed at the external surface 14 of the adapter sleeve 6, viewed in observation direction 8, at least behind the fixing device 10. This causes—as it will be explained by means of further Figures—an additional improved positioning accuracy for accessories 7 attached to the observation telescope 3 by means of the adapter sleeve 6.

The fixing device 10 of the adapter sleeve 6 is preferably, as shown in FIG. 1, disposed in the end section 23 on the observer's side or at least in a third of the total length of the adapter sleeve 6 on the observer's side, with the result that behind it, in observation direction 18, sufficient space for the external centering sections 16, 18 or the fastening section 21 is provided.

FIG. 2 shows a longitudinal section through an adapter sleeve 6 attached to an eyepiece portion 2 indicated by dashed lines, to which adapter sleeve 6 an accessory 7, also indicated by dashed lines, for example in the form of a fixture 5 is attached. In this exemplary embodiment, the fixing device 10 is arranged directly at the end on the observer's side of the basic body 9 and it is used for effecting the fastening forces working between adapter sleeve 6 and eyepiece portion 2. Subsequently, in observing direction 18, the inner surface 11 forms the inner centering surface 12, which is provided for centering the adapter sleeve 6 at the external circumference 13 of the eyepiece portion 2.

The attachment portion 21 of the adapter sleeve 6 is in this case arranged between the external centering sections 16, 19 with the result that the accessory 7 is supported on both sides of the attachment portion 21 and an eccentric displacement with respect to the optical axis 8 can be avoided due to clamping forces.

At this stage, it should be noted that the fixing device 10 itself is able to effect a centering of the adapter sleeve 6 on the eyepiece portion 2 and that an inner centering surface 12 may transfer forces between the adapter sleeve 2 and the eyepiece portion 2. For differentiation between an inner centering surface 12 and a fixing device 10 it is stated that the fixing device 10 exerts fastening forces onto the eyepiece portion 2 in the form of clamping forces, compressive forces, tractive forces or tensioning forces securing the position of the adapter sleeve 6 at the eyepiece portion 2, whereas at an inner centering surface 12, merely a supporting of the adapter sleeve 6 at the eyepiece portion 2 is effected, with the result that between inner centering surface 12 and eyepiece portion 2, forces are essentially caused when the adapter sleeve 6 is subjected to external loads by the weight of the accessory 7.

Between one inner centering surface 12 of the adapter sleeve 6 and an external diameter of the eyepiece portion 2, there is generally a minimal clearance, in order to allow the adapter sleeve 6 to be attached onto the eyepiece portion 2 without any problems. In contrast thereto, a clearance between adapter sleeve 6 and eyepiece portion 2 in the region of the fixing device 10 can be largely excluded. A fixing device 10 furthermore causes the position locking of the adapter sleeve in the axial observation direction 18, whereas an inner centering surface 12 does not considerably contribute to a position locking in axial direction.

In the embodiment according to FIG. 2, the external centering section 19 and the attachment portion 21 viewed in observation direction 18, are completely situated behind the fixing device 10.

FIGS. 3 and 4 show the effects of a clearance between the inner centering surface 12 at the inner surface 11 of the adapter sleeve 6 and the external circumference 13 of the eyepiece portion 2, if a moment caused by the weight of a recording or measuring device 1 is slid on or tilted over the adapter sleeve 6 and its effect on the positioning accuracy of the accessory 7 or the fixture 5 and thus also on the recording or measuring device 1. This being the case, FIG. 3 shows the relations when an adapter sleeve 6 according to the invention is used and FIG. 4 shows the proportions when an adapter sleeve according to prior art is used.

The radial clearance and the resulting oblique positions are shown in exaggerated representation for clearer demonstration. The steps of the external centering surface 15 according to the invention formed by external centering sections 16, 19 having different external diameters 17, 20 are not shown in FIG. 3 to simplify matters.

FIG. 3 shows, that a load torque 24 acting in clockwise direction, slightly tilts and deforms the adapter sleeve 6 at the eyepiece portion 2, with the fixing device 10 arranged at the right end of the adapter sleeve 6 forming to some extent a pivot point 25 for the tilting movement, as there is, as explained above, no clearance between the adapter sleeve 6 and the eyepiece portion 2. Thus, the section of the adapter sleeve 6 on the left of the fixing device 10 is slightly lifted with respect to the optical axis 8 of the eyepiece portion 2. According to the invention, the accessory 7 is, viewed in observation direction 18, fastened to either the attachment portion 21 of the adapter sleeve 6 behind the fixing device 10 or at least centered at an external centering surface 15 of the adapter sleeve 6, with the result that a second pivot point 26 for tilting accessory 7 relative to the adapter sleeve 6 may be formed. Due to the acting load torque 24, it is possible that the accessory 7 is continued to be slightly tilted in clockwise direction additionally with respect to the adapter sleeve 6, with the result that section of the accessory 7, in FIG. 3 situated on the right of the second pivot point 26, slightly lowers at increasing distance to the pivot point 26. Due to these displacements in opposite directions that at least partially cancel each other out, it is possible for the position deviation of a recording or measuring device 1 at the fixture 5 or the accessory 7 of the optical axis 8 to be kept lower than in the embodiment of an adapter sleeve 6 according to prior art shown in FIG. 4. In this case, is e.g. the fixing device 10 arranged at the objective-side end of the adapter sleeve 6 and thereby, a first pivot point 25 for tilting the adapter sleeve 6 by the load torque 24 is formed. Any sections of the adapter sleeve 6, in FIG. 4 situated on the right of the pivot point 25, are subject to a slight lowering below the optical axis 8 due to the load torque 24 and thus, it is likewise the second pivot point 26 formed from attachment portion 21 arranged on the right of the fixing device 10.

In the embodiment of an adapter sleeve 6 shown in FIG. 4, the complete lowering of an accessory 7, e.g. in the form of a fixture 5, is correspondingly greater than in the embodiment of an adapter sleeve 6 according to FIG. 3. Although the deviation is only fractional parts of millimeters, an adapter sleeve 6 according to FIG. 3 allows obtaining a further improved, optical reproduction quality by using a recording or measuring device 1.

FIG. 5 shows a longitudinal section through a possible embodiment of an adapter sleeve 6 by means of which an accessory 7 (see FIGS. 1 to 4) may be attached to an eyepiece portion (see FIGS. 1 to 4). The adapter sleeve 6 comprises an essentially hollow-cylindrical basic body 9, which may be slid on an eyepiece portion 2 in observation direction 18 and is on the observer's side end portion 23 provided with a fixing device 10, by means of which the adapter sleeve 6 is fastened to the eyepiece portion 2. In the embodiment shown, the fixing device 10 comprises several resilient clamping elements 27 e.g. resilient lugs, which may be deformed in radial direction with respect to the optical axis 8 by means of a clamping body 28 and can thus be pressed onto the eyepiece portion 2. Together, the clamping elements 27 form a collet 29, as it is known from the field of the machine tools and the individual clamping elements 27 may be formed by slots 30 in the basic body 8. At their exterior face, the clamping elements 27 are formed conically and may be clamped in radial direction at the external circumference of an eyepiece portion 2 by means of the clamping body 28, here in the form of a cap nut 31. For this purpose, the cap nut 31 engages with an internal thread 32 into an appropriate external thread 33 at the basic body 9 and causes that the adapter sleeve 6 is evenly and very centrically clamped in the region of this fixing device 10.

In addition to the inner centering surface 12 formed from the fixing device 10, the adapter sleeve 6 has on its inner surface 11 a further inner centering surface 12 which is arranged in the, in observation direction 18, rear end section 24. As already explained on the basis of FIGS. 3 and 4, the inner centering surface 12 may be considered as being free of clearance in the region of the fixing device 10, whereas the second inner centering surface 11 in the region of the objective-side end portion 34 usually comprises a slight clearance with respect to the external circumference of the eyepiece portion 2, although this only concerns fractions of a millimeter.

As shown in FIG. 5, it is furthermore possible for the adapter sleeve 6 to have a stop element 35 for the accessory 7, which stop element 35 radially protrudes outwardly at the external surface 14. In the embodiment shown in FIG. 5, it is formed from an external collar 36 at the objective-side end section 34. Due to this stop element 35, it is possible to ease the repetition of the same axial positioning of an accessory 7 at the adapter sleeve 7.

The external centering surface 15 provided for centering an attachment part 7 fastened to the outside is according to the invention composed from the at least two or several external centering sections 16 and 19 that are spaced apart from one another by a recess 37 having a reduced external diameter 38. As shown in FIG. 5, e.g. also the external circumference of the cap nut 31 may be e.g. used as external centering section 16.

The external centering surface 15 or the individual exterior entering sections 16, 19 have in this case a constant external diameter each, with the result that it is possible for the accessory 7 at the external surface 14 to be adjusted in observation direction 18. It is in this case possible that a transition section 39 having a conically increasing external diameter is arranged before at least one of the external centering sections 16, 19 in observation direction 18, with the result that it is easier to slide the accessory 7 on the adapter sleeve 6.

The recess 37 having a reduced external diameter 38 can particularly form the attachment portion 21 whereto the attachment of the accessory 7 by means of fastening means at the accessory 7 can take place. As shown by FIG. 5, in this exemplary embodiment, a part of the external surface 14, namely the rear external centering section 19 viewed in observation direction 18 and also the attachment portion 21 in the form of a recess 37, is situated behind the fixing device 10, with the result that also the further improved attachment of an accessory pert 7 described by means of FIG. 3 can be effected.

With an adapter sleeve 6 according to the invention, the inner surface 11, having the inner centering surface 12 and the fixing device 10, is adapted to the respective dimensions of an eyepiece portion 2 and therefore, different kinds of embodiment of the inner surface 11 or their inner centering surfaces 12 or the fixing device 10 are required for different types of eyepieces. In order to avoid that each different adapter sleeve 6 adapted to one respective type of eyepiece requires a respective special accessory 7 it is of advantage if the external surface 14 in terms of its external centering surface 15 and attachment portion 21 has essentially identical dimensions for each different kind of the adapter sleeve 6.

FIG. 6 shows a further and, if applicable, independent embodiment of an adapter sleeve 6, and the same parts described are again denoted by the same reference numbers and the same component names as in the preceding FIGS. 1 to 5. In order to avoid unnecessary repetitions, it is referred to the detailed descriptions of the preceding FIGS. 1 to 5.

This embodiment has an external surface 14, which essentially corresponds to that in FIG. 5, i.e. the external diameters 17, 20 of the external centering sections 16, 19 have dimensions, with the result that it is possible for a part 7, which can be put onto an adapter sleeve 6 according to FIG. 5, to be also put onto an adapter sleeve according to FIG. 6. The first external diameter 17 is e.g. 62 mm and the second external diameter 20 is e.g. 63 mm.

The inner surface 11 is designed to be different from that in the embodiment according to FIG. 5 and the adapter sleeve 6 is therefore provided for a different embodiment of an eyepiece portion 2. The fixing device 10 is arranged at the end portion 23 on the observer's side. By derogation from the embodiment in FIG. 5, where the radial clamping of the adapter sleeve 6 is effected onto the external circumference of the eyepiece portion 2, the fixing device 10 according to FIG. 6 causes an axial pressing of the adapter sleeve 6 onto the eyepiece portion 2 in observation direction 18, e.g. onto its eyepiece housing, as it is e.g. shown in FIG. 7.

For this purpose the adapter sleeve 6 or its basic body 9 has a radially inwardly protruding stop element 40 that forms a stop surface 41 which can be axially pressed against the end surface of an eyepiece housing. Between the stop surface 41 and the eyepiece housing it is furthermore possible to provide an intermediate ring 42 by means of which the axial position of the adapter sleeve 6 with respect to the eyepiece portion 2 may be determined. Such a stop element 40 may also be provided for a fixing device according to FIG. 5 or another embodiment of a fixing device 10, it is however absolutely necessary for an adapter sleeve 6 according to FIG. 6. The axial pressing of the adapter sleeve 6 against the eyepiece portion 2 is effected by means of an axial tensioning element 43 that may be attached to the eyepiece portion 2 and can press the adapter sleeve 2 against the eyepiece portion 2 in axial direction, with the result that a force- and/or form-locking fixing is effected. It is possible for the axial tensioning element 43 to be, as shown in FIG. 6, formed from a screw-in sleeve 44 which may be screwed into a hollow-cylindrical eyepiece housing by means of an external thread 45 and which has an external collar 56 by means of which the adapter sleeve 6 may be tensed against the eyepiece housing in observation direction 18. This screw-in sleeve 44 may advantageously similarly be an integral part of an eye cup arrangement 47, an eye cup 48 of which is mounted in the screw-in sleeve 44 to be adjustable. As indicated in FIG. 6, it is possible for this fixture to be performed by a helical guide bar, with the result that an axial twisting of the eye cup 48 results in an axial adjustment of the latter.

Also in this embodiment of an adapter sleeve 6, at least parts of the external centering surface 15 or the attachment portion 21 are arranged to be subsequent to the fixing device 10 in observation direction 18, with the result that the stable and precisely positioned mounting of an accessory 7 at the adapter sleeve 6 may be effected. It is possible for the adapter sleeve 6 to have a basic body 9 having a relatively thin wall thickness, if the shape of the inner surface 11 is well adapted to the eyepiece portion 2. As further shown in FIG. 6, a locally thinner wall thickness 49 may be provided in the attachment portion 21, with the result that at least a part of the fastening forces exerted by the accessory 7 in the attachment portion 21 to the basic body 9 are transferred into the eyepiece portion 2. For this purpose, the attachment portion 21 is arranged in the region of an inner centering surface 12 and it is thus possible for the fastening forces to be transferred without significantly deforming the adapter sleeve 6 into the eyepiece portion 2 engaged by the latter.

FIG. 7 shows a longitudinal section through an eyepiece arrangement 50, where an adapter sleeve 6 according to the embodiment in FIG. 6 is fastened to an eyepiece portion 2. The eyepiece arrangement 50 comprises in this case an eyepiece housing 51 similar to a hollow-cylinder, wherein the eyepiece lens optics 52 indicated by dashed lines is disposed.

For fastening the adapter sleeve 6 to the eyepiece housing 51, it is axially slid onto the eyepiece housing 51 in observation direction 18 until the stop surface 41 of the stop element 40 rests against an axial pressing face 53 of the eyepiece housing 51. In the exemplary embodiment shown, the axial pressing face 53 similarly represents the end face of the eyepiece housing 51, it is furthermore possible that another axial pressing face at another inwardly or outwardly protruding stop element is provided.

As shown in FIG. 7 by dashed lines, the stop surface 41 and the end face of the eyepiece housing 51 can have a contour 54 that is not rotationally symmetric, with the result that it is possible for the adapter sleeve 6 to be secured against twisting around the optical axis 8 not only in a force- but also in a form-locking way.

The fixing of the adapter sleeve 6 is effected by means of the screw-in sleeve 44 which can be screwed into the eyepiece housing 51 by means of an external thread 45. The external collar 46 at the end of the observer's side of the screw-in sleeve 44 forms a second axial pressing face 55 pressing the radially inwardly protruding stop element 40 of the adapter sleeve 6 against the axial pressing face 53 at the eyepiece housing 51. The external diameter 56 of the axial pressing face 55 of the eye cup arrangement 47 preferably approximately corresponds to the external diameter of the eyepiece housing 51, with the result that an axial sliding of an accessory 7 onto the adapter sleeve 6 is not impeded. It is thereby possible for the axial contact force to be distributed over the end face of the adapter sleeve 6 on the observer's side as extensively as possible.

FIG. 8 schematically shows an adapter system 57 comprising different adapter sleeves 6, 6′, 6″, . . . and different fixtures 5, 5′, 5″, . . . .

Albeit their interiors may be designed to differ from one another, the different adapter sleeves 6, 6′, 6″, . . . have essentially identically formed connecting surfaces 58 for a fixture 5 and essentially identical exterior dimensions. Albeit their exteriors may be designed to differ from one another, the different fixtures 5, 5′, 5″, . . . have further essentially identical connecting surfaces 59 for an adapter sleeve 6 and essentially identical interior dimensions.

The connecting surfaces 58, 59 form hence a uniform interface allowing a plurality of combinations. The shape of the connecting surfaces 58, 59 is not limited to the illustrated leveled embodiment, but also further shapes of connecting surfaces 58, 59 suitable for mutual positioning and centering of adapter sleeve 6 and fixture 5 are possible.

The embodiments illustrated as examples represent possible variants of the adapter sleeve or the eyepiece arrangement 50, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the design of the adapter sleeve 5 or the eyepiece arrangement 45, they and their constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1; 2; 3, 4; 5; 6; 7; 8 constitute independent solutions proposed by the invention in their own right. The objectives and associated solutions proposed by the invention may be found in the detailed descriptions of these drawings.

List of Reference Numerals

| | |
|---|---|
| 1 | Recording or measuring device |
| 2 | Eyepiece portion |
| 3 | Observation telescope |
| 4 | Attachment adapter |
| 5 | Fixture |
| 6 | Adapter sleeve |
| 7 | Accessory |
| 8 | Optical axis |
| 9 | Basic body |
| 10 | Fixing device |
| 11 | Inner surface |
| 12 | Inner centering surface |
| 13 | External circumference |
| 14 | External surface |
| 15 | External centering surface |
| 16 | External centering section |
| 17 | External diameter |
| 18 | Observation direction |
| 19 | External centering section |
| 20 | External diameter |
| 21 | Attachment portion |
| 22 | Fastening means |
| 23 | End portion |
| 24 | Load torque |
| 25 | Pivot point |
| 26 | Pivot point |
| 27 | Clamping element |
| 28 | Clamping body |
| 29 | Collet |
| 30 | Slot |
| 31 | Cap nut |
| 32 | Internal thread |
| 33 | External thread |
| 34 | End portion |
| 35 | Stop element |
| 36 | External collar |
| 37 | Recess |
| 38 | External diameter |
| 39 | Transition section |
| 40 | Stop element |
| 41 | Stop surface |
| 42 | Intermediate ring |
| 43 | Axial tensioning element |
| 44 | Screw-in sleeve |
| 45 | External thread |
| 46 | External collar |
| 47 | Eye cup arrangement |
| 48 | Eye cup |
| 49 | Wall thickness |
| 50 | Eyepiece arrangement |
| 51 | Eyepiece housing |
| 52 | Eyepiece lens optics |
| 53 | Axial pressing face |
| 54 | Contour |
| 55 | Axial pressing face |
| 56 | External diameter |
| 57 | Adapter system |
| 58 | Connecting surface |
| 59 | Connecting surface |

1. An adapter sleeve for fastening an accessory, in particular a fixture for an optical recording or measuring device, to an eyepiece portion of an observation telescope comprising:
a basic body similar to a hollow-cylinder having an inner surface which has at least an inner centering surface for centering the adapter sleeve at the eyepiece portion, in particular at an external circumference of the same, and having an external surface having an external centering surface for centering the accessory at the adapter sleeve;
an attachment portion for the detachable fastening of the accessory to the adapter sleeve, and
a fixing device for force- and/or form-locking position locking of the adapter sleeve at the eyepiece portion,
wherein the external centering surface comprises at least a first and second external centering section each having a constant external diameter,
wherein the constant external diameters of the first external centering sections is smaller than the constant external diameter of the second external centering section in an observation direction.

2. The adapter sleeve according to claim 1, wherein the external diameter from the first external centering section to the second external centering section increases by a value between 1% and 10%.

3. The adapter sleeve according to claim 1, wherein the attachment portion is arranged between the first and second external centering sections that are spaced apart from one another in the observation direction.

4. The adapter sleeve according to claim 1, wherein the attachment portion has an external diameter which is reduced with respect to the first and second external centering sections and is formed as a recess, flute or groove extending across an entire external circumference of the adapter sleeve.

5. The adapter sleeve according to claim 4, wherein the recess, flute or groove is between 5 mm and 12 mm in the observation direction.

6. The adapter sleeve according to claim 1, wherein at least one of the first and second external centering sections and/or the attachment portion of the external surface are at least partially arranged behind the fixing device when viewed in the observation direction.

7. The adapter sleeve according to claim 6, wherein at least one of the first or second external centering sections and/or the attachment portion of the external surface are completely arranged behind the fixing device when viewed in the observation direction.

8. The adapter sleeve according to claim 1, wherein the fixing device is disposed in an end portion of the adapter sleeve on an observer's side,
wherein the fixing device is located on an outer most third of the observer's side end portion.

9. The adapter sleeve according to claim 1, wherein the external surface of the basic body has a radially outwardly protruding stop element for the accessory,
wherein the radially outwardly protruding stop element is an external collar at the observation direction end region of the adapter sleeve.

10. The adapter sleeve according to claim 1, further comprising:
a transition section having a conically increasing external diameter,
wherein the transition section is arranged before at least one of the first and second external centering sections when viewed in the observation direction.

11. The adapter sleeve according to claim 1, wherein the attachment portion coincides with an inner centering surface on an inner surface of the adapter sleeve.

12. The adapter sleeve according to claim 11, wherein the attachment portion is thinner in wall thickness than adjacent sections of the adapter sleeve,
wherein at least a portion of the fastening forces exerted to the basic body by the accessory in the attachment portion is transferred to the eyepiece portion.

13. The adapter sleeve according to claim 1, wherein the basic body has a radially inwardly protruding stop element that forms a stop surface for an axial resting of the adapter sleeve at the eyepiece portion,
wherein the radially inwardly protruding stop element that forms the stop surface is located at an end face of an eyepiece housing.

14. The adapter sleeve according to claim 1, wherein the fixing device further comprises:
a clamping device having at least one resilient and circumferentially distributed clamping elements at the basic body,
wherein the clamping device includes a collet, and a clamping body that radially displace a cap nut.

15. The adapter sleeve according to claim 1, wherein the fixing device further comprises:
a radially inwardly protruding stop element at the basic body,
wherein the radially inwardly protruding stop element includes
a stop surface for an axial resting of the basic body at the eyepiece portion, wherein the stop surface is preferably not rotationally symmetric, and
an axial tensioning element that can be attached to a screw-in sleeve of the eyepiece portion.

16. The adapter sleeve according to claim 15, wherein the axial tensioning element is embodied as an eye cup arrangement that may be screwed into the eyepiece portion.

17. An attachment adapter for fastening an optical recording or measuring device to an eyepiece portion of an observation telescope, comprising:
an adapter sleeve that may be fixed to an eyepiece portion; and
a fixture that may be fixed to the optical recording or measuring device,
wherein the adapter sleeve and the fixture have a common detachable mechanical interface, wherein the adapter sleeve further comprises:
a basic body similar to a hollow-cylinder having an inner surface which has at least an inner centering surface for centering the adapter sleeve at the eyepiece portion, in particular at an external circumference of the same, and having an external surface having an external centering surface for centering the accessory at the adapter sleeve;
an attachment portion for the detachable fastening of the accessory to the adapter sleeve, and
a fixing device for force- and/or form-locking position locking of the adapter sleeve at the eyepiece portion,
wherein the external centering surface comprises at least a first and second external centering section each having a constant external diameter, with the external diameters of the first and second external centering sections increasing in an observation direction, and
the fixture has an inner centering surface cooperating with at least one of the first and second external centering sections,
wherein two or more interior centering sections have different interior diameters and cooperate with the first and second external centering sections.

18. An adapter system for fastening an optical recording or measuring device to different eyepiece portions of different observation telescopes and/or different optical recording or measuring devices to an eyepiece portion of an observation telescope, wherein the adapter system comprises:
at least two different sized hollow-cylindrical adapter sleeves that may be fixed to the eyepiece portion,
at least different sized fixtures that may be fixed to the optical recording or measuring device and attachable to an adapter sleeve
wherein the different sized adapter sleeves have different interior designs with essentially identical connecting surfaces for the fixture and essentially identical exterior dimensions,
wherein the different sized fixtures have different exterior designs with essentially identical connecting surfaces for the adapter sleeve and essentially identical interior dimensions.

19. An eyepiece arrangement for an observation telescope comprising:
a hollow-cylindrical eyepiece housing,
an eyepiece lens optics positioned inside the eyepiece housing,
a hollow-cylindrical eye cup arrangement closing the eyepiece housing on an observer's side, and
an adapter sleeve surrounding the eyepiece housing, for fastening an accessory to the eyepiece housing, wherein the accessory is a fixture for an optical recording or measuring device,
wherein an end portion on the observer's side of the adapter sleeve is pressed against an axial pressing face or end face at the eyepiece housing by an axial pressing face at the eye cup arrangement.

20. The eyepiece arrangement according to claim 19, wherein an external diameter of the axial pressing face of the eye cup arrangement approximately corresponds to an external diameter of the eyepiece housing.
